(19) United States
(12) Patent Application Publication
(10) Pub. No.: US 2025/0244541 A1
(43) Pub. Date: Jul. 31, 2025

(54) OPTICAL CONNECTOR CONNECTION STRUCTURE

(71) Applicant: Nippon Telegraph and Telephone Corporation, Tokyo (JP)

(72) Inventors: Kota Shikama, Tokyo (JP); Ryo Nagase, Tokyo (JP); Yuzo Ishii, Tokyo (JP); Norio Sato, Tokyo (JP)

(21) Appl. No.: 18/693,378

(22) PCT Filed: Sep. 28, 2021
(86) PCT No.: PCT/JP2021/035656

§ 371 Date: Mar. 12, 2025

(51) Int. Cl. G02B 6/38

(52) U.S. Cl. CPC G02B 6/3886; G02B 6/3877; G02B 6/3882

(57) ABSTRACT

Opposing connection end faces of optical fibers (1a and 1b) and opposing connection end faces of ferrules (20a and 20b) are inclined with respect to a direction orthogonal to a longitudinal direction of the optical fibers (1a and 1b). Opposing connection end faces of magnetic structures (21a and 21b) are inclined with respect to the direction orthogonal to the longitudinal direction of the optical fibers (1a and 1b), a magnetic force generated between the magnetic structures (21a and 21b) acts in a direction orthogonal to the connection end faces of the optical fibers (1a and 1b) and the connection end faces of the ferrules (20a and 20b).

### TECHNICAL FIELD

The present invention relates to a technique for connecting optical connectors to each other, and more particularly to an optical connector connection structure in which a magnetic force is used to achieve reduction in loss.

### BACKGROUND ART

For an optical connector that connects optical fibers for communication to each other, a physical contact (hereinafter abbreviated as PC) type optical connector for closely connecting fiber cores to each other by butting and pressing high-precision ferrules to each other is often used (see NPL 1).

In the PC connection, since the cores can mutually be in a state in which they are completely in close contact with each other, it is possible to prevent Fresnel reflection with air, and a high return loss can be obtained. As single-core connectors, FC connectors, SC connectors, MU connectors, LC connectors, and the like are known. All of these connectors realize PC connection using a structure in which single-core ferrules are pressed against each other in a split sleeve by a spring provided at rear end portions of the ferrules.

In addition, an angled PC (APC) type optical connector in which end faces of ferrules are formed to be oblique end faces and connected to each other is known as a structure in which a high return loss can be obtained and low reflection is realized. By using the oblique end faces, recombination of reflected return light to cores hardly occurs, and thus a high return loss can be obtained than a PC type optical connector of a right angle end face type.

The optical connector structure using oblique end faces is also used in a multicore optical connector for collectively connecting a plurality of optical fibers and is also applied to a multicore connector known as an MPO connector. In the MPO connector, MT ferrules fitted to each other by a guide pin provided therein are pressed by springs provided at rear end portions of the ferrules, and cores are closely connected to each other. In addition, even if an air layer is formed between the cores, reflected return light is not recombined due to the effect of the oblique end faces, and a high return loss can be maintained. In both of the APC connector and the MPO connector, an end face angle shifted by 8 degrees from a right angle is adopted as an end face angle in a normal single mode fiber application.

However, in an optical connector having oblique end faces, since a direction of a pressing force applied by springs and an angle formed by a pair of ferrule end faces are not orthogonal to each other, a component force in a sliding direction acts on the ferrule end faces at the time of connection, and a stress component orthogonal to a longitudinal direction of fibers is generated. When a spring force is defined as F, for example, in the case of the end faces inclined by 8 degrees, a component of F×sin8° theoretically exists.

In a connector having oblique end faces such as an APC connector and an MPO connector, there is a problem that axial misalignment between cores of fibers is caused by the component force, and a connection loss is increased. In addition, in order to reduce the connection loss, there is a problem of requiring advanced ingenuity such as offsetting the axial misalignment in consideration of the influence of the component force in advance.

For example, in an APC connector, as disclosed in NPL 2, it is known that the above-mentioned component force is applied to a split sleeve, and the split sleeve is asymmetrically deformed depending on a direction around an axis of a split position of the split sleeve, thereby resulting in variations in connection loss.

Also, in an MPO connector, a component force is similarly applied in a direction orthogonal to a longitudinal direction of fibers, a position of a guide pin is biased in a guide pin hole due to the component force in a sliding direction, and the guide pin hole is slightly elastically deformed, and thus slight axial misalignment occurs between cores, and connection loss is increased. In order to avoid coaxial misalignment in the MPO connector, ingenuity such as offsetting a fiber hole position in a ferrule in consideration of the above-described component force in the sliding direction has been studied, but such an offset structure requires advanced know-how and strict tolerance regulations.

### CITATION LIST

### Non Patent Literature

[NPL 1] Ryo Nagase, Yoshiteru Abe, Mitsuru Kihara, “History of Fiber Optic Physical Contact Connector for Low Insertion and High Return Losses”, Proc. IEEE HISTory of Electrotechnology CONference (HISTELCON), 2017

[NPL 2] Katsuyoshi Sakaime, Kenta Arai, Shiro Aono, Ryo Nagase, “Microsopic Deformation Analysis of Split Sleeves for Optical Connector”, Journal of the Japan Institute of Electronics Packaging, Vol. 21, No. 2, p. 160-165, 2018

### SUMMARY OF INVENTION

### Technical Problem

The present invention has been made to solve the above problems, and an object of the present invention is to reduce a connection loss in an optical connector connection structure for connecting optical connectors to each other, in which end faces of optical fibers and ferrules are formed to be oblique end faces.

### Solution to Problem

An optical connector connection structure of the present invention includes a first optical connector attached to a tip of a first optical fiber and a second optical connector attached to a tip of a second optical fiber and connectable to the first optical connector, wherein the first optical connector includes a first alignment component configured to fix the first optical fiber and a first magnetic structure integrated with the first alignment component, the second optical connector includes a second alignment component configured to fix the second optical fiber and a second magnetic structure integrated with the second alignment component, connection end faces of the first and second optical fibers and connection end faces of the first and second alignment components, which are opposed to each other in the case of connecting the first optical connector to the second optical connector, are inclined with respect to a direction orthogonal to a longitudinal direction of the first and second optical fibers so that all of the end faces are parallel to each other, connection end faces of the first and second magnetic structures, which are opposed to each other in the case of connecting the first optical connector to the second optical connector, are inclined with respect to the direction orthogonal to a longitudinal direction of the first and second optical fibers so that they are parallel to the connection end faces of the first and second optical fibers and the connection end faces of the first and second alignment components, and a magnetic force generated between the first and second magnetic structures acts in a direction orthogonal to the connection end faces of the first and second optical fibers and the connection end faces of the first and second alignment components.

Also, an optical connector connection structure of the present invention includes a first optical connector attached to a tip of a first optical fiber and a second optical connector attached to a tip of a second optical fiber and connectable to the first optical connector, wherein the first optical connector includes a first alignment component configured to fix the first optical fiber and a first magnetic structure integrated with the first alignment component, the second optical connector includes a second alignment component configured to fix the second optical fiber and a second magnetic structure integrated with the second alignment component, connection end faces of the first and second optical fibers and connection end faces of the first and second alignment components, which are opposed to each other in the case of connecting the first optical connector to the second optical connector, are inclined with respect to a direction orthogonal to a longitudinal direction of the first and second optical fibers so that all of the end faces are parallel to each other, at least one of the first and second magnetic structures includes a structure made of a hard magnetic material so that a magnetic force generated between the first and second magnetic structures in the case of connecting the first optical connector to the second optical connector acts in a direction orthogonal to the connection end faces of the first and second optical fibers and the connection end faces of the first and second alignment components, and a magnetization direction of the hard magnetic material is set in the direction orthogonal to the connection end faces of the first and second optical fibers and the connection end faces of the first and second alignment components.

Also, one configuration example of the optical connector connection structure of the present invention further includes: a split sleeve configured to connect the first optical connector to the second optical connector; and a third magnetic structure attached to a periphery of the split sleeve to provide connection between the first magnetic structure and the second magnetic structure in the case of connecting the first optical connector to the second optical connector, wherein the first alignment component is a cylindrical ferrule that fixes the first optical fiber such that the connection end face of the first optical fiber is exposed on the connection end face thereof, the second alignment component is a cylindrical ferrule that fixes the second optical fiber such that the connection end face of the second optical fiber is exposed on the connection end face thereof; the first and second alignment components are inserted into the split sleeve from both sides of the split sleeve and positioned in the case of connecting the first optical connector to the second optical connector so that the connection end faces of the first and second alignment components are butted to each other, both connection end faces of the third magnetic structure opposing the connection end faces of the first and second magnetic structures in the case of connecting the first optical connector to the second optical connector are inclined with respect to the direction orthogonal to the longitudinal direction of the first and second optical fibers so that they are parallel to the connection end faces of the first and second optical fibers and the connection end faces of the first and second alignment components, and the first magnetic structure and the second magnetic structure are connected to each other by a magnetic force via the third magnetic structure.

Also, one configuration example of the optical connector connection structure of the present invention further includes: a split sleeve configured to connect the first optical connector to the second optical connector; and a third magnetic structure attached to a periphery of the split sleeve to provide connection between the first magnetic structure and the second magnetic structure in the case of connecting the first optical connector to the second optical connector, wherein the first alignment component is a cylindrical ferrule that fixes the first optical fiber such that the connection end face of the first optical fiber is exposed on the connection end face thereof, the second alignment component is a cylindrical ferrule that fixes the second optical fiber such that the connection end face of the second optical fiber is exposed on the connection end face thereof; the first and second alignment components are inserted into the split sleeve from both sides of the split sleeve and positioned in the case of connecting the first optical connector to the second optical connector so that the connection end faces of the first and second alignment components are butted to each other, at least one of the first, second, and third magnetic structures includes a structure made of a hard magnetic material so that the first magnetic structure and the second magnetic structure are connected to each other by a magnetic force via the third magnetic structure in the case of connecting the first optical connector to the second optical connector, and a magnetization direction of the hard magnetic material is set in the direction orthogonal to the connection end faces of the first and second optical fibers and the connection end faces of the first and second alignment components.

Also, one configuration example of the optical connector connection structure of the present invention further includes a guide pin configured to connect the first optical connector to the second optical connector, wherein the first alignment component is a ferrule including a guide pin hole and fixes the first optical fiber so that connection end faces of a plurality of the first optical fibers are exposed on the connection end face thereof, the second alignment component is a ferrule including a guide pin hole and fixes the second optical fiber so that connection end faces of a plurality of the second optical fibers are exposed on the connection end face thereof, and the guide pin is inserted into the guide pin holes of each of the first and second alignment components in the case of connecting the first optical connector to the second optical connector and positioned such that the connection end faces of the first and second alignment components are butted to each other.

In addition, in one configuration example of the optical connector connection structure of the present invention, the first magnetic structure is made of a soft magnetic material, and the second magnetic structure includes a first member made of a soft magnetic material opposing the first magnetic structure in the case of connecting the first optical connector to the second optical connector, and a second member made of a hard magnetic material disposed on an end face side opposite to a connection end face of the first member.

Also, one configuration example of the optical connector connection structure of the present invention further includes: a guide pin configured to connect the first optical connector to the second optical connector; and a third magnetic structure disposed to provide connection between the first magnetic structure and the second magnetic structure in the case of connecting the first optical connector to the second optical connector, wherein the first alignment component is a ferrule including a guide pin hole and fixes the first optical fiber so that connection end faces of a plurality of the first optical fibers are exposed on the connection end face thereof, the second alignment component is a ferrule including a guide pin hole and fixes the second optical fiber so that connection end faces of a plurality of the second optical fibers are exposed on the connection end face thereof, the guide pin is inserted into the guide pin holes of the first and second alignment components in the case of connecting the first optical connector to the second optical connector and positioned so that the connection end faces of the first and second alignment components are butted to each other, both connection end faces of the third magnetic structure opposing the connection end faces of the first and second magnetic structures in the case of connecting the first optical connector to the second optical connector are inclined with respect to the direction orthogonal to the longitudinal direction of the first and second optical fibers so that they are parallel to the connection end faces of the first and second optical fibers and the connection end faces of the first and second alignment components, and the first magnetic structure and the second magnetic structure are connected to each other by a magnetic force via the third magnetic structure.

Also, one configuration example of the optical connector connection structure of the present invention further includes: a guide pin configured to connect the first optical connector to the second optical connector; and a third magnetic structure disposed to provide connection between the first magnetic structure and the second magnetic structure in the case of connecting the first optical connector to the second optical connector, wherein the first alignment component is a ferrule including a guide pin hole and fixes the first optical fiber so that connection end faces of a plurality of the first optical fibers are exposed on the connection end face thereof, the second alignment component is a ferrule including a guide pin hole and fixes the second optical fiber so that connection end faces of a plurality of the second optical fibers are exposed on the connection end face thereof, the guide pin is inserted into the guide pin holes of the first and second alignment components in the case of connecting the first optical connector to the second optical connector and positioned so that the connection end faces of the first and second alignment components are butted to each other, at least one of the first, second, and third magnetic structures includes a structure made of a hard magnetic material so that the first magnetic structure and the second magnetic structure are connected to each other by a magnetic force via the third magnetic structure in the case of connecting the first optical connector to the second optical connector, and a magnetization direction of the hard magnetic material is set in the direction orthogonal to the connection end faces of the first and second optical fibers and the connection end faces of the first and second alignment components.

### Effects of Invention

According to the present invention, the magnetic force generated between first and second magnetic structures in the case of connecting the first optical connector to the second optical connector acts in the direction orthogonal to the connection end faces of first and second optical fibers and the connection end faces of first and second alignment components, whereby no component force is generated in the direction orthogonal to the longitudinal direction of the optical fibers, and thus variations in connection loss can be inhibited, and low-loss optical connection can be realized.

### BRIEF DESCRIPTION OF DRAWINGS

FIG. 1A is a cross-sectional view before connection of a single-core optical connector connection structure according to a first example of the present invention.

FIG. 1B is a cross-sectional view after connection of the single-core optical connector connection structure according to the first example of the present invention.

FIGS. 2A and 2B are cross-sectional views showing another example of the single-core optical connector connection structure according to the first example of the present invention.

FIG. 3 is a cross-sectional view showing another example of the single-core optical connector connection structure according to the first example of the present invention.

FIG. 4 is a cross-sectional view showing another example of the single-core optical connector connection structure according to the first example of the present invention.

FIG. 5 is a cross-sectional view showing another example of the single-core optical connector connection structure according to the first example of the present invention.

FIG. 6A is a cross-sectional view before connection of a single-core optical connector connection structure according to a second example of the present invention.

FIG. 6B is a cross-sectional view after connection of the single-core optical connector connection structure according to the second example of the present invention.

FIG. 7A is a perspective view before connection of a multicore optical connector connection structure according to a third example of the present invention.

FIG. 7B is a perspective view after connection of the multicore optical connector connection structure according to the third embodiment of the present invention.

FIGS. 8A and 8B are cross-sectional views after connection of the multicore optical connector connection structure according to the third example of the present invention.

FIG. 9A is a perspective view before connection of a multicore optical connector connection structure according to a fourth example of the present invention.

FIG. 9B is a perspective view after connection of the multicore optical connector connection structure according to the fourth example of the present invention.

FIG. 10 is a cross-sectional view after connection of the multicore optical connector connection structure according to the fourth example of the present invention.

FIG. 11A is a perspective view before connection of a multicore optical connector connection structure according to a fifth example of the present invention.

FIG. 11B is a perspective view after connection of the multicore optical connector connection structure according to the fifth example of the present invention.

FIG. 12 is a cross-sectional view after connection of the multicore optical connector connection structure according to the fifth example of the present invention.

FIG. 13 is a cross-sectional view showing another example of the multicore optical connector connection structure according to the fifth embodiment of the present invention.

FIG. 14A is a perspective view before connection of a multicore optical connector connection structure according to a sixth example of the present invention.

FIG. 14B is a perspective view after connection of the multicore optical connector connection structure according to the sixth example of the present invention.

### DESCRIPTION OF EMBODIMENTS

### First Example

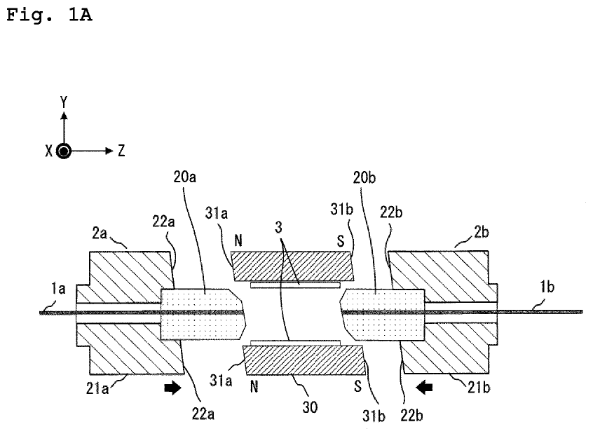

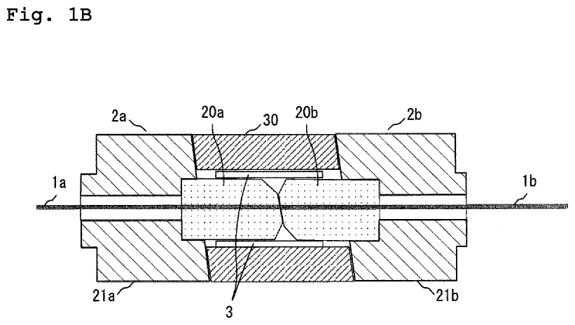

Examples of the present invention will be described in detail below with reference to the drawings. FIG. 1A is a cross-sectional view before connection of a single-core optical connector connection structure according to a first example of the present invention, and FIG. 1B is a cross-sectional view after connection of the single-core optical connector connection structure.

As shown in FIGS. 1A and 1B, the single-core optical connector connection structure of the present example includes optical connectors 2a and 2b attached to tips of each of optical fibers 1a and 1b and a split sleeve 3 that connects ferrules of the optical connectors 2a and 2b to each other.

The optical fibers 1a and 1b are, for example, quartz single mode fibers having a clad diameter of 125 μm and a core diameter of about 10 μm.

The optical connector 2a includes a ferrule 20a (a first alignment component) attached to the tips of the optical fibers 1a and a magnetic structure 21a (a first magnetic structure) attached to a periphery of the ferrule 20a. Similarly, the optical connector 2b includes a ferrule 20b (a second alignment component) attached to the tips of the optical fibers 1b and a magnetic structure 21b (a second magnetic structure) attached to a periphery of the ferrule 20b.

The ferrules 20a and 20b are known single-core ferrules with micro holes having inner diameters larger than outer diameters of the optical fibers 1a and 1b, for example, by 0.5 to 1.5 μm. The optical fibers 1a and 1b from which coatings are removed are inserted into the micro holes of the ferrules 20a and 20b. The optical fibers 1a and 1b and the ferrules 20a and 20b are fixed by an adhesive. In addition, in FIGS. 1A and 1B, illustration of the adhesive and the optical fiber coatings is omitted.

As is well known, the split sleeve 3 is formed by cutting and splitting a cylindrical sleeve in a longitudinal direction of a center line. A magnetic structure 30 (a third magnetic structure) is attached to a periphery of the split sleeve 3.

In the present example, as shown in FIG. 1B, the ferrules 20a and 20b of the pair of optical connectors 2a and 2b are inserted into the split sleeve 3 from both sides of the split sleeve 3, the ferrules 20a and 20b are butted to each other, and the optical fibers 1a and 1b are butted to each other, thereby connecting the optical connectors 2a and 2b. Positioning of the ferrules 20a and 20b, that is, positioning of the optical fibers 1a and 1b, is performed by the split sleeve 3.

Materials of each of the magnetic structures 21a, 21b, and 30 and magnetization directions of N and S poles thereof are set so that a magnetic attraction force acts between the magnetic structures 21a and 30 and between the magnetic structures 21b and 30.

In the present example, the magnetic structure 30 is made of a hard magnetic material (so-called a magnet). As shown in FIG. 1A, when a longitudinal direction of the optical fibers 1a and 1b is defined as a Z axis direction, the N and S poles are magnetized in the Z axis direction. As a material of the magnet, any of known magnets may be used in accordance with a magnetic force to be generated. As a representative magnet, a neodymium magnet can be used. In addition, known magnets such as a ferrite magnet, an alnico magnet, a samarium cobalt magnet, a KS steel, a MK steel, and a neodymium iron boron magnet can be used for the magnetic structure 30. Also, any magnet whose magnetic characteristics are adjusted by slightly changing compositions of these can be naturally used in the same way.

As the material of the magnetic structures 21a and 21b, a hard magnetic material (magnet) or a soft magnetic material may be used. When a hard magnetic material is used, its magnetization direction is appropriately set to correspond to the magnetization direction of the magnetic structure 30. For example, when a connection end face 31a side of the magnetic structure 30 is an N pole, a connection end face 22a side of the magnetic structure 21a facing the connection end face 31a is set to an S pole, and a connection end face 22b side of the magnetic structure 21b facing a connection end face 31b of the magnetic structure 30 is set to an N pole. Thus, magnetic attraction forces acts so that the connection end face 31a of the magnetic structure 30 and the connection end face 22a of the magnetic structure 21a attract each other, and the connection end face 31b of the magnetic structure 30 and the connection end face 22b of the magnetic structure 21b attract each other.

Even when a soft magnetic material is used as the material of the magnetic structures 21a and 21b, similar magnetic attraction forces act between the magnetic structure 30 and the magnetic structure 21a and between the magnetic structure 30 and the magnetic structure 21b. As the soft magnetic material, a metal or the like attracted to a magnet is known, and there are, for example, iron, nickel, cobalt, permalloy, and the like. In addition, among stainless steel (SUS), which is an iron-based alloy, magnetic stainless steel (for example, SUS430) can be used.

When all the magnetic structures 21a 21b, and 30 are made of magnets, the generated magnetic forces are naturally large, and attraction forces are large. On the other hand, the magnetic structures 21a and 21b may be made of soft magnetic materials from the viewpoint of easiness of processing, prevention of sticking to other components, prevention of influence of the magnetic forces, and the like although the attraction forces are inferior to those when all the magnetic structures 21a, 21b, and 30 are made of magnets. Whether the hard magnetic materials or the soft magnetic materials are used as the materials of the magnetic structures 21a and 21b can be selected appropriately in accordance with required attraction forces, sizes of the magnetic structures 21a, 21b, and 30, required conditions, and the like. Also, a soft magnetic material may be used as the material of the magnetic structure 30, and a hard magnetic material may be used as at least one of the magnetic structures 21a and 21b.

Further, any of the magnetic structures 21a, 21b, and 30 may also be a composite of a plurality of magnetic structures without being composed of one material, or a combination of a hard magnetic material and a soft magnetic material may be used therefor.

As a method for joining the ferrules 20a and 20b and the magnetic structures 21a and 21b, any joining method such as adhesion, mechanical fitting, or metal joining (soldering or the like) may be used. The same applies to a joining method between the split sleeve 3 and the magnetic structure 30.

In the present example, a sum of an amount of protrusion in the Z axis direction of an end face of the ferrule 20a from the magnetic structure 21a and an amount of protrusion in the Z axis direction of an end face of the ferrule 20b from the magnetic structure 21b is set equal to or slightly larger than a length of the magnetic structure 30 in the Z axis direction. End faces of the optical fibers 1a and 1b are exposed to the end faces of the ferrules 20a and 20b. Accordingly, when the ferrules 20a and 20b are inserted into the split sleeve 3 from both sides of the split sleeve 3 and the end faces of the ferrules 20a and 20b are brought into contact with each other, the end faces of the optical fibers 1a and 1b are brought into contact with each other, and PC connection is realized.

On the other hand, by setting the amount of protrusion as described above, the connection end face 22a of the magnetic structure 21a and the connection end face 31a of the magnetic structure 30, and the connection end face 22b of the magnetic structure 21b and the connection end face 31b of the magnetic structure 30 are not necessarily in contact with each other, and a minute gap may be formed between the connection end faces.

As is apparent from FIGS. 1A and 1B, the connection end faces of the ferrules 20a and 20b and the connection end faces of the optical fibers 1a and 1b have so-called oblique end faces inclined to a direction orthogonal to the Z axis direction. Specifically, the connection end faces of the ferrules 20a and 20b and the connection end faces of the optical fibers 1a and 1b are oblique end faces inclined by, for example, 8° with respect to an XY plane perpendicular to the Z axis direction. That is, it has a structure similar to that of an APC connector in which fibers on oblique end faces are closely connected to each other.

As shown in FIG. 1A and FIG. 1B, chamfering may be applied to outer peripheral portions of the connection end faces of the ferrules 20a and 20b.

The connection end face 22a of the magnetic structure 21a opposing the magnetic structure 30 is inclined by 8° with respect to the XY plane perpendicular to the Z axis direction to be approximately parallel to the connection end face of the ferrule 20a integrated with the magnetic structure 21a and the connection end faces of the optical fibers 1a. Similarly, the connection end face 22b of the magnetic structure 21b opposing the magnetic structure 30 is inclined by 8° with respect to the XY plane to be approximately parallel to the connection end face of the ferrule 20b integrated with the magnetic structure 21b and the connection end faces of the optical fibers 1b.

In addition, the connection end faces 31a and 31b of the magnetic structure 30 opposing the magnetic structures 21a and 21b are inclined by 8° with respect to the XY plane to be approximately parallel to the connection end faces 22a and 22b of the magnetic structures 21a and 21b when the optical connectors 2a and 2b are connected to each other. That is, a cross-sectional shape of the magnetic structure 30 surrounding the split sleeve 3 has an outer shape like a parallelogram.

In the present example, the following effects can be obtained by adopting the structures of the magnetic structures 21a, 21b, and 30 as described above. In present example, the magnetic attraction force acting between the magnetic structure 21a and the magnetic structure 30 and the magnetic attraction force acting between the magnetic structure 21b and the magnetic structure 30 act in a direction orthogonal to the connection end faces 22a, 22b, 31a, and 31b, that is, in the direction inclined by 8° with respect to an XZ plane.

In a configuration in which ferrules are brought into close contact with each other by applying a pressing force from rear ends of the ferrules using springs or the like as in known techniques, if angles of connection end faces of the ferrules and directions of forces of the springs are not orthogonal to each other, a component force in a sliding direction is applied. For this reason, as described above, there is a possibility that a component force is generated on a split sleeve in a direction orthogonal to a longitudinal direction of optical fibers, causing the split sleeve to deform asymmetrically. Since there are individual differences in directions of slits in the split sleeve, there is a problem that variations in deformation of the split sleeve occur, resulting in increased variations in connection loss.

On the other hand, in the structure of the present example, the magnetic attraction force is applied only in the direction orthogonal to the connection end faces of the ferrules 20a and 20b, the connection end faces of the optical fibers 1a and 1b, and the connection end faces 22a, 22b, 31a, and 31b of the magnetic structures 21a 21b, and 30, and thus a component force is not generated in the direction orthogonal to the longitudinal direction (Z axis direction) of the optical fibers 1a and 1b, and the split sleeve 3 is not deformed asymmetrically. As a result, the present example has the effect of being able to inhibit variations in connection loss and realize low-loss optical connection as designed.

Also, although the magnetic structures 21a and 21b are disposed to surround peripheries of the ferrules 20a and 20b in the structure shown in FIG. 1A and FIG. 1B, any structure other than that shown in FIGS. 1A and 1B may be used as long as it can generate a magnetic force. For example, a magnetic structure may be disposed only on one sides of the ferrules 20a and 20b.

Also, the magnetic structures 21a, 21b, and 30 may not be made of a single material, and may be a combination of a hard magnetic material and a soft magnetic material. Further, a combination of hard magnetic materials, for example, a combination of magnetic materials having a half-split structure, or a multipolar magnet may be used.

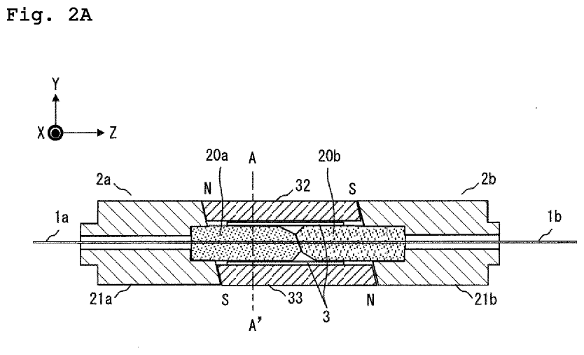

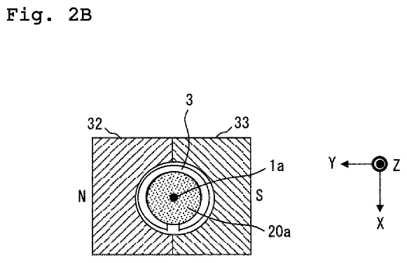

FIG. 2A shows an example in which the third magnetic structure is split into two magnets as one modified example of the present example. FIG. 2B shows a cross-section of the optical connector connection structure taken along line A-A′ in FIG. 2A. In the example of FIGS. 2A and 2B, magnetic structures 32 and 33, which are two half-split magnets having opposite magnetization directions, are disposed at a periphery of the split sleeve 3. In the case of this example, magnetic confinement can be strengthened, and a magnetic force can be increased even if the size is the same as that of the structure shown in FIG. 1A and FIG. 1B.

Also, other structures may be used as a connection structure of the magnetic structures. For example, when the magnetic structures are viewed in the Z axis direction, a structure in which a hard magnetic material and a soft magnetic material are separately disposed may be used, or when the magnetic structures are viewed in a direction perpendicular to the Z axis direction (an X axis direction or a Y axis direction), a structure in which a hard magnetic material and a soft magnetic material are separately disposed may be used. Further, the ferrules 20a and 20b themselves may have built-in magnetic structures.

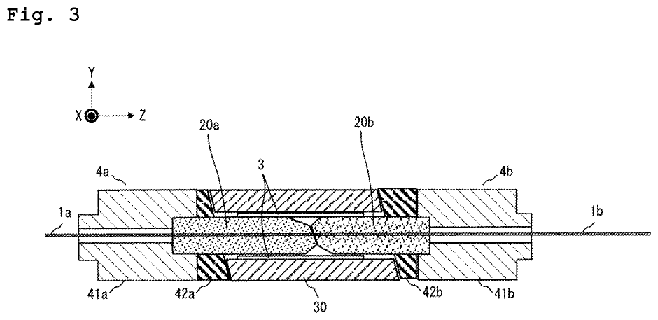

FIG. 3 shows another modified example of the present example. An optical connector 4a includes a ferrule 20a and magnetic structures 41a and 42a attached to a periphery of the ferrule 20a. An optical connector 4b includes a ferrule 20b and magnetic structures 41b and 42b attached to a periphery of the ferrule 20b.

In the example shown in FIG. 3, the first magnetic structure is configured of a magnetic structure 41a having an end face orthogonal to the Z axis direction, and a magnetic structure 42a of which an end face on the magnetic structure 41a side is orthogonal to the Z axis direction and a connection end face on the magnetic structure 30 side is inclined with respect to the direction orthogonal to the Z axis direction. The second magnetic structure is configured of a magnetic structure 41b having an end face orthogonal to the Z axis direction and a magnetic structure 42b of which an end face on the magnetic structure 41b side is orthogonal to the Z axis direction and a connection end face on the magnetic structure 30 side is inclined with respect to the direction orthogonal to the Z axis direction. Even if the magnetic structure is divided and configured in this way, the same effects as those of the example in FIG. 1A and FIG. 1B can be obtained.

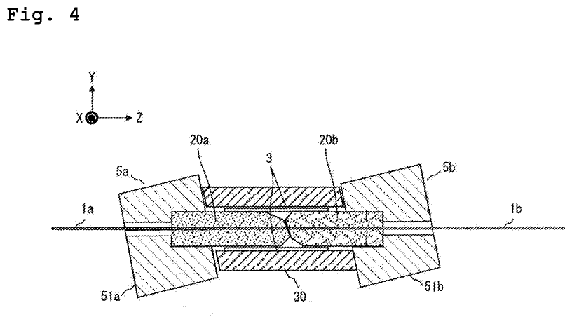

FIG. 4 shows another modified example of the present example. An optical connector 5a includes a ferrule 20a and a magnetic structure 51a attached to a periphery of the ferrule 20a. An optical connector 5b includes a ferrule 20b and a magnetic structure 51b attached to a periphery of the ferrule 20b.

In the example of FIG. 4, holes for the optical fibers 1a and 1b and holes for the ferrules 20a and 20b obliquely penetrate the rectangular parallelepiped magnetic structures 51a and 51b. Thus, since a configuration in which the connection end faces of the magnetic structures 51a and 51b are inclined with respect to the direction orthogonal to the Z axis direction is adopted, the same effects as those of the example of FIG. 1A and FIG. 1B can be obtained.

In addition, in the present example, an example in which the connection end faces of the ferrules 20a and 20b, the connection end faces of the optical fibers 1a and 1b, and the connection end faces of the magnetic structures 21a, 21b, 30, 32, 33, 42a, 42b, 51a, and 51b are inclined by 8° with respect to the XY plane perpendicular to the Z axis direction has been described, but it is needless to say that inclination angles of the connection end faces may be values other than 8° in the present invention.

Next, other constituent elements of the present invention will be described. In the present invention, for types and materials of the optical fibers 1a and 1b and types and materials of the ferrules 20a and 20b, any known ones can be used. For example, the optical fibers 1a and 1b may be any of well-known quartz-based optical fibers or plastic fibers. Also, as for the optical fibers 1a and 1b, the present invention can be applied to any of single mode fibers, multimode fibers, polarization holding fibers, photonic crystal fibers, multicore fibers, and the like.

Further, in portions exposed to the outside of the ferrules 20a and 20b, for example, known resin coatings made of acrylic, epoxy, silicone, polyimide, or the like may be provided around the optical fibers 1a and 1b, or two or more types of layers including a silicone tube, a nylon coating, or the like may be provided around the resin coatings. The ferrules 20a and 20b can be used in any of known cylindrical ferrules.

In addition, in the present invention, any component other than ferrules can be used for the alignment components as long as it can position the end faces of the optical fibers 1a and 1b with high precision.

Further, in the present invention, a component other than the split sleeve 3 may be used as long as it can position the ferrules 20a and 20b with high accuracy.

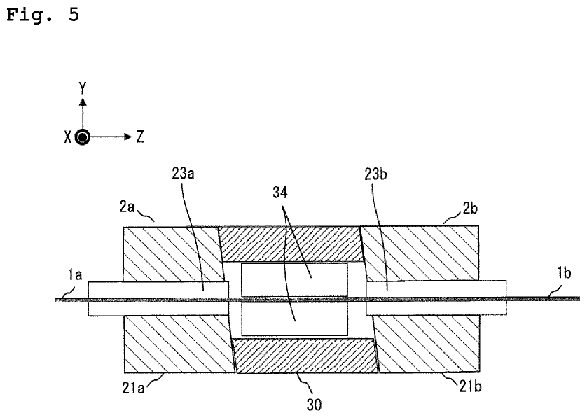

For example, FIG. 5 shows an application example. In the example shown in FIG. 5, glass capillaries 23a and 23b are used for the alignment components for fixing the optical fibers 1a and 1b. Micro holes slightly larger than outer diameters of the optical fibers 1a and 1b are formed in the capillaries 23a and 23b. The optical fibers 1a and 1b are respectively inserted into the micro holes of the capillaries 23a and 23b and fixed such that the connection end faces of the optical fibers 1a and 1b protrude from end faces of the capillaries 23a and 23b. The optical fibers 1a and 1b and the capillaries 23a and 23b are fixed by an adhesive. Similarly to the example of FIG. 1A and FIG. 1B, the connection end faces of the optical fibers 1a and 1b are inclined with respect to the direction orthogonal to the Z axis direction.

In addition, in the example shown in FIG. 5, a capillary 34 in which a micro hole slightly larger than the outer diameters of the optical fibers 1a and 1b is formed is used for a component for positioning the optical fibers 1a and 1b. The two optical fibers 1a and 1b are positioned by aligning the optical fibers 1a and 1b protruding from the capillaries 23a and 23b in the micro hole of the capillary 34.

Similarly to the example of FIG. 1A and FIG. 1B, the magnetic structures 21a and 21b are attached to peripheries of the capillaries 23a and 23b, and the magnetic structure 30 is attached to a periphery of the capillary 34. The materials of each of the magnetic structures 21a, 21b, and 30 and the magnetization directions of the N and S poles thereof are appropriately set so that magnetic attraction forces act between the magnetic structure 21a and the magnetic structure 30, and between the magnetic structure 21b and the magnetic structure 30.

For example, magnetic attraction forces act between the magnetic structure 21a and the magnetic structure 30 and between the magnetic structure 21b and the magnetic structure 30 by using SUS403 for the magnetic structures 21a and 21b and a neodymium magnet for the magnetic structure 30. Also in the example shown in FIG. 5, since the magnetic attraction force acting between the magnetic structure 21a and the magnetic structure 30 and the magnetic attraction force acting between the magnetic structure 21b and the magnetic structure 30 act in directions inclined to the XZ plane, no component force is generated in the direction orthogonal to the longitudinal direction (Z axis direction) of the optical fibers 1a and 1b. For this reason, it is possible to prevent an increase in connection loss due to axial misalignment of the optical fibers 1a and 1b within a range of clearance in the micro hole of the capillary 34, and to perform optical connection with low loss.

### Second Example

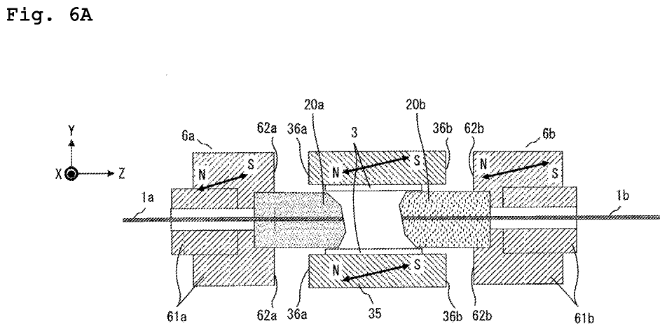

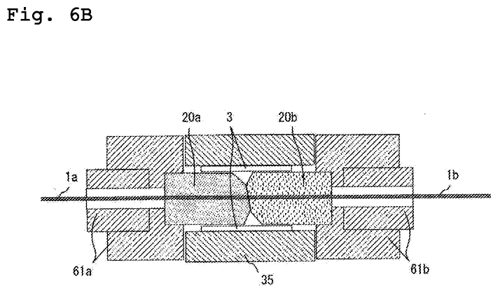

FIG. 6A is a cross-sectional view before connection of a single-core optical connector connection structure according to a second example of the present invention, and FIG. 6B is a cross-sectional view after connection of the single-core optical connector connection structure.

The single-core optical connector connection structure of the present example includes optical connectors 6a and 6b attached to tips of each of the optical fibers 1a and 1b and a split sleeve 3 that connects ferrules of the optical connectors 6a and 6b.

The optical connector 6a includes a ferrule 20a (the first alignment component) attached to the tips of the optical fibers 1a and a magnetic structure 61a (the first magnetic structure) attached to a periphery of the ferrule 20a. Similarly, the optical connector 6b includes a ferrule 20b (the second alignment component) attached to the tips of the optical fibers 1b and a magnetic structure 61b (the second magnetic structure) attached to a periphery of the ferrule 20b.

A magnetic structure 35 (the third magnetic structure) is attached to a periphery of the split sleeve 3.

In the present example, as shown in FIG. 6B, the ferrules 20a and 20b of the pair of optical connectors 6a and 6b are inserted into the split sleeve 3 from both sides of the split sleeve 3, the ferrules 20a and 20b are butted to each other, and the optical fibers 1a and 1b are butted to each other, thereby connecting the optical connectors 6a and 6b. Similarly to the first example, connection end faces of the ferrules 20a and 20b and connection end faces of the optical fibers 1a and 1b are inclined by, for example, 8° with respect to the XY plane perpendicular to the longitudinal direction (Z axis direction) of the optical fibers 1a and 1b.

A difference from the first example is that both of connection end faces 62a and 62b of the magnetic structures 61a and 61b and connection end faces 36a and 36b of the magnetic structure 35 are perpendicular to the longitudinal direction (Z axis direction) of the optical fibers 1a and 1b and are not inclined with respect to the XY plane.

On the other hand, in the present example, the magnetic structures 61a, 61b, and 35 are made of hard magnetic materials, and their magnetization directions are inclined with respect to the Z axis direction as shown in FIG. 6A. Specifically, magnetization directions of N and S poles are set in a direction orthogonal to the connection end faces of the ferrules 20a and 20b and the connection end faces of the optical fibers 1a and 1b.

In the present example, by setting the magnetization directions, even if the connection end faces 62a, 62b, 36a, and 36b of the magnetic structures 61a, 61b, and 35 are perpendicular to the Z axis direction, a magnetic attraction force acting between the magnetic structures 61a and 35 and a magnetic attraction force acting between the magnetic structure 61b and the magnetic structure 35 act obliquely with respect to the Z axis direction, and a magnetic force is applied in a direction orthogonal to the connection end faces of the optical fibers 1a and 1b and the connection end faces of the ferrules 20a and 20b.

In the present example, since the magnetic attraction force is applied only in the direction orthogonal to the connection end faces of the optical fibers 1a and 1b and the connection end faces of the ferrules 20a and 20b, a component force is not generated in the direction orthogonal to the Z axis direction, and asymmetric deformation is not generated in the split sleeve 3. As a result, the present example has the effect of being able to inhibit variations in connection loss, and realize low-loss optical connection as designed.

### Third Example

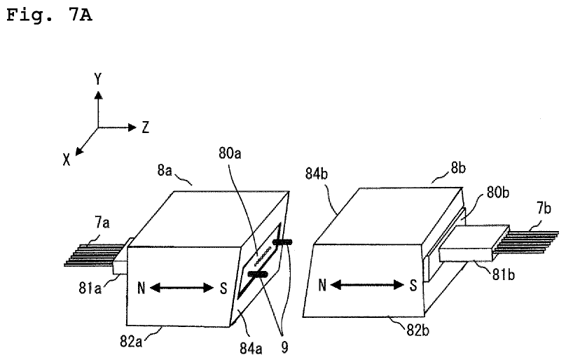

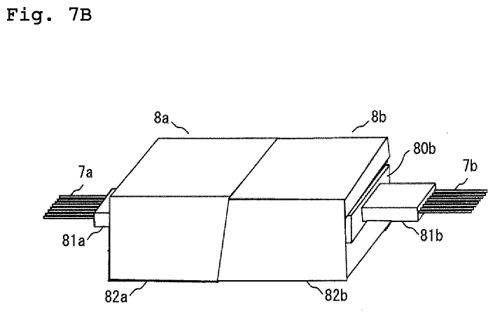

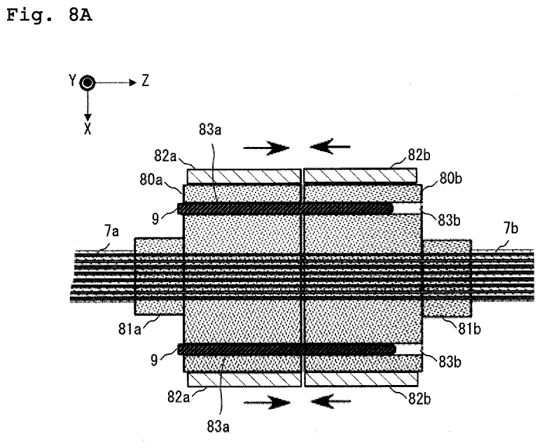

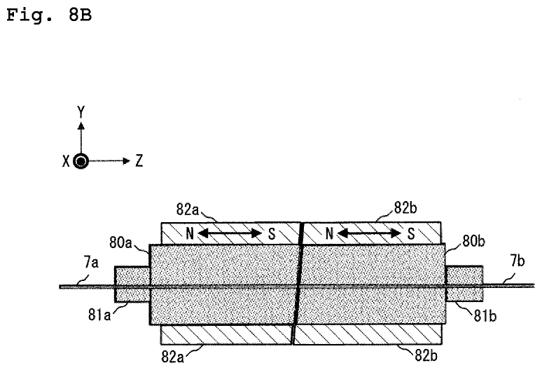

FIG. 7A is a perspective view before connection of a multicore optical connector connection structure according to a third example of the present invention, and FIG. 7B is a perspective view after connection of the multicore optical connector connection structure. FIG. 8A is a cross-sectional view of the multicore optical connector connection structure of FIG. 7B taken along the XZ plane, and FIG. 8B is a cross-sectional view of the multicore optical connector connection structure of FIG. 7B taken along a YZ plane.

The multicore optical connector connection structure of the present example includes an optical connector 8a attached to tips of a plurality of optical fibers 7a, an optical connector 8b attached to tips of a plurality of optical fibers 7b, and guide pins 9 that connect ferrules of the optical connectors 8a and 8b to each other.

The optical connector 8a includes a ferrule 80a (the first alignment component) attached to the tips of the optical fibers 7a, a boot 81a that bundles the optical fiber 7a, and a magnetic structure 82a (the first magnetic structure) attached to a periphery of the ferrule 80a. Similarly, the optical connector 8b includes a ferrule 80b (the second alignment component) attached to the tips of the optical fibers 7b, a boot 81b that bundles the optical fiber 7b, and a magnetic structure 82b (the second magnetic structure) attached to a periphery of the ferrule 80b.

The ferrules 80a and 80b are multicore ferrules including a plurality of micro holes into which the plurality of optical fibers 7a and 7b are inserted. The ferrules 80a and 80b are known MT ferrules, and two guide pin holes 83a and 83b penetrating the ferrules 80a and 80b are formed in the longitudinal direction (Z axis direction) of the optical fibers 7a and 7b.

The optical fibers 7a from which coatings are removed are inserted one by one into the plurality of micro holes of the ferrule 80a. Similarly, the optical fibers 7b from which coatings are removed are inserted one by one into the plurality of micro holes of the ferrule 80b. The optical fibers 7a and 7b and the ferrules 80a and 80b are fixed by an adhesive. In addition, in FIGS. 7A, 7B, 8A, and 8B, the adhesive and the optical fiber coatings are not shown.

In the present example, as shown in FIGS. 7B, 8A, and 8B, the guide pins 9 are inserted one by one into the two guide pin holes 83a of the ferrule 80a of the optical connector 8a, these guide pins 9 are inserted into the guide pin holes 83b of the ferrule 80b of the optical connector 8b, the ferrules 80a and 80b are butted to each other, and the optical fibers 7a and 7b are butted to each other, thereby connecting the optical connectors 8a and 8b. Positioning of the ferrules 80a and 80b, that is, positioning of the optical fibers 7a and 7b, is performed by the guide pins 9.

As shown in FIG. 8B, connection end faces of the ferrules 80a and 80b and connection end faces of the optical fibers 7a and 7b are inclined by, for example, 8° with respect to the XY plane perpendicular to the Z axis direction. Thus, recombination of return light due to Fresnel reflection can be prevented.

Materials of each of the magnetic structures 82a and 82b and magnetization directions of N and S poles are set so that a magnetic attraction force acts between the magnetic structure 82a attached to the periphery of the ferrule 80a and the magnetic structure 82b attached to the periphery of the ferrule 80b.

A connection end face 84a of the magnetic structure 82a opposing the magnetic structure 82b is inclined by 8° with respect to the XY plane perpendicular to the Z axis direction to be approximately parallel to the connection end face of the ferrule 80a integrated with the magnetic structure 82a and the connection end faces of the optical fibers 7a. Similarly, a connection end face 84b of the magnetic structure 82b opposing the magnetic structure 82a is inclined by 8° with respect to the XY plane to be approximately parallel to the connection end face of the ferrule 80b integrated with the magnetic structure 82b and the connection end faces of the optical fibers 7b.

The optical fibers 7a and 7b are positioned to slightly protrude from the connection end faces of the ferrules 80a and 80b, and the connection end faces of the optical fibers 7a and 7b are polished. Also, although an example in which the connection end face 84a of the magnetic structure 82a and the connection end face of the ferrule 80a are positioned to be aligned on the same plane has been shown, the connection end face of the ferrule 80a may be positioned to protrude from the connection end face 84a of the magnetic structure 82a. Similarly, the connection end face 84b of the magnetic structure 82b and the connection end face of the ferrule 80b are positioned to be aligned on the same plane, but the connection end face of the ferrule 80b may be positioned to protrude from the connection end face 84b of the magnetic structure 82b.

In the present example, the following effects can be obtained by employing the above-described structures of the magnetic structures 82a and 82b. In the present example, the magnetic attraction force acting between the magnetic structure 82a and the magnetic structure 82b acts in a direction orthogonal to the connection end faces 84a and 84b, that is, in the direction inclined by 8° with respect to the XZ plane.

In a configuration in which ferrules are brought into close contact with each other by applying a pressing force from rear ends of multicore ferrules using springs or the like as in known techniques, a component force in a sliding direction is applied unless angles of connection end faces of the ferrules and directions of forces of the springs are orthogonal to each other. For this reason, as described above, a component force is generated in a direction orthogonal to a longitudinal direction of optical fibers, and there is a possibility that positions of guide pins may be biased in guide pin holes due to the component force in the sliding direction. Further, there is a possibility that the guide pin holes may be slightly elastically deformed by the component force. As a result, there is a problem that a slight axial misalignment occurs between cores of the optical fibers and the connection loss increases.

Further, in order to avoid coaxial misalignment in known MPO connectors, ingenuity such as offsetting fiber hole positions in ferrules in consideration of a component force in a sliding direction in advance has been studied, but such an offset structure requires advanced know-how and strict tolerance regulations. In particular, minute deformation of guide pin holes due to a component force in a sliding direction changes depending on a pressing force and material characteristics of the ferrules. For this reason, advanced know-how is required to make the minute deformation of the guide pin holes as designed. In addition, when optical connectors of different vendors are connected to each other, there is a problem that axial misalignment of optical fiber cores cannot be controlled as assumed, and connection loss may increase.

On the other hand, in the structure of the present example, since a magnetic attraction force is applied only in the direction orthogonal to the connection end faces of the ferrules 80a and 80b, the connection end faces of the optical fibers 7a and 7b, and the connection end faces 84a and 84b of the magnetic structures 82a and 82b, a component force is not generated in the direction orthogonal to the longitudinal direction (Z axis direction) of the optical fibers 7a and 7b, and minute deformation of the guide pin holes 83a and 83b is not generated. As a result, the present example has the effect of being able to inhibit variations in connection loss and realize low-loss optical connection as designed.

In addition, in the present example, it is not necessary to offset the fiber hole positions in the ferrules 80a and 80b in consideration of the component force in the sliding direction. Even if the fiber hole positions in the ferrules 80a and 80b are offset, influence of the minute deformation of the guide pin holes 83a and 83b can be eliminated, and thus the offset positions can be easily set regardless of a magnetic attraction force and material characteristics. For this reason, even when the optical connectors 8a and 8b of different vendors are connected to each other, low-loss optical connection can be realized.

Next, other constituent elements in the present example will be described. In the present example, the modified examples and the application examples shown in the first example can also be applied.

For example, in the structure shown in FIGS. 7A, 7B, 8A, and 8B, the magnetic structures 82a and 82b are disposed to surround the ferrules 80a and 80b, but any structure other than that shown in FIGS. 7A, 7B, 8A, and 8B may be used as long as it can generate a magnetic force. For example, the magnetic structures may be disposed only on one sides of the ferrules 80a and 80b.

Also, the magnetic structures 82a and 82b may not be made of a single material, and may be a combination of a hard magnetic material and a soft magnetic material. Further, a combination of hard magnetic materials, for example, a combination of magnetic materials having a half-split structure as described in the first example, or a multipolar magnet may be used.

Also, other structures may be used as the connection structure of the magnetic structures. For example, when the magnetic structures are viewed in the Z axis direction, a structure in which a hard magnetic material and a soft magnetic material are separately disposed may be used, or when the magnetic structures are viewed in a direction perpendicular to the Z axis direction (X axis direction or Y axis direction), a structure in which a hard magnetic material and a soft magnetic material are separately disposed may be used. Further, the ferrules 80a and 80b themselves may have built-in magnetic structures.

In addition, as in the example of FIG. 3, the magnetic structure 82a may be configured of the magnetic structure 41a having an end face orthogonal to the Z axis direction, and the magnetic structure 42a of which an end face on the magnetic structure 41a side is orthogonal to the Z axis direction and a connection end face on the magnetic structure 82b side is inclined with respect to the direction orthogonal to the Z axis direction. Similarly, the magnetic structure 82b may be configured of the magnetic structure 41b having an end face orthogonal to the Z axis direction and the magnetic structure 42b of which an end face on the magnetic structure 41b side is orthogonal to the Z axis direction and a connection end face on the magnetic structure 82a side is inclined with respect to the direction orthogonal to the Z axis direction.

In addition, as in the example shown in FIG. 4, holes for the optical fibers 7a and 7b and holes for the ferrules 80a and 80b may obliquely pass through a rectangular parallelepiped magnetic structure.

In the present example, any known types and materials of the optical fibers 7a and 7b and types and materials of the ferrules 80a and 80b can be applied. Any of general-purpose plastics, engineering plastics, super engineering plastics, or the like, which are often used for MT ferrules, may be used as the materials of the multicore ferrules 80a and 80b.

Also, in the same structure as the ferrules 80a and 80b, a glass material may be used, or a processed product based on a semiconductor material such as silicon, a ceramic material or the like may be used. For example, the optical fibers 7a and 7b may be held and fixed between a glass block formed with a V-groove and a lid component like a known optical fiber array. By positioning and bonding two guide pins or the like to the glass block and the lid component, a ferrule made of a glass material having a positioning structure may be realized.

In addition, as long as a configuration in which the connection end faces of the ferrules 80a and 80b, the connection end faces of the optical fibers 7a and 7b, and the connection end faces 84a and 84b of the magnetic structures 82a and 82b are inclined with respect to the XY plane perpendicular to the Z axis direction and a magnetic attraction force is applied in the direction orthogonal to these connection end faces, outer shapes of the ferrules 80a and 80b and outer shapes of the magnetic structures 82a and 82b may differ from those shown in FIGS. 7A, 7B, 8A, and 8B.

Further, if necessary, the ferrules 80a and 80b and the magnetic structures 82a and 82b may be chamfered, filleted, or otherwise processed. These processes may be applied to other examples.

In the present example, as an alignment structure, the structure including the guide pins 9 and the guide pin holes 83a and 83b used in an MT ferrule or the like is adopted, but an alignment structure other than the present example may be used.

For example, a protrusion may be formed on a connection end face of one of the ferrules 80a and 80b, and a guide groove to be fitted to the protrusion may be provided on a connection end face of the other ferrule.

Also, the present invention can be similarly applied even if the optical fibers 1a, 1b, 7a, and 7b are replaced with optical waveguides or optical elements. Further, Fresnel reflection may be further inhibited by applying antireflection coatings or the like to the connection end faces of the optical fibers 1a, 1b, 7a, and 7b as necessary.

Also, in the present example, an example in which the optical fibers 7a and 7b are positioned to protrude from the connection end faces of the ferrules 80a and 80b has been described, but the preset invention is not limited thereto. For example, the optical fibers 7a and 7b may be positioned so that the connection end faces thereof are slightly recessed from the connection end faces of the ferrules 80a and 80b, and a slight gap may be provided between the optical fibers 7a and 7b while the opposing ferrules 80a and 80b are brought into contact with each other. In addition, in order to provide a gap between the optical fibers 7a and 7b, another spacer component may be provided between the ferrules 80a and 80b. Further, the relationship between the connection end faces of the ferrules and the connection end faces of the magnetic structures can be designed arbitrarily. For example, the connection end face of the ferrule 80a may be set to be recessed with respect to the connection end face 84a of the magnetic structure 82a in order to provide a gap between the optical fibers, and the connection end face 84b of the other magnetic structure 82b and the connection end face of the ferrule 80b may also be set to be recessed. On the contrary, as a configuration for PC connection, the connection end face of the ferrule may be set to protrude from the connection end face of any magnetic structure. Further, the connection end face of the ferrule 80a may be set to be recessed with respect to the connection end face 84a of one magnetic structure 82a, and the connection end face 84b of the other magnetic structure 82b and the connection end face of the ferrule 80b may be set to protrude. In this case, a recessed length of the connection end face of the ferrule 80a with respect to the connection end face 84a of the magnetic structure 82a and a protruding length of the connection end face of the ferrule 80b with respect to the connection end face 84b of the other magnetic structure 82b are set to be approximately the same, and thus a configuration in which the optical fibers are PC-connected to each other can be realized as shown in FIG. 7.

The 8-core optical fibers 7a and 7b are disposed at, for example, a pitch of about 250 μm. Naturally, the pitch and the number of cores of the optical fibers 7a and 7b are arbitrary, and any number of cores such as 2 cores, 4 cores, 8 cores, 12 cores, 16 cores, 24 cores, and 32 cores can be applied. Also, a part of the optical fibers 7a and 7b may be a polarization maintaining fiber or the like.

In addition, in order to prevent the guide pins 9 from falling off, the guide pins 9 may be fixed to either one of the ferrules 80a and 80b. As a fixing method, there are a method of fixing using other parts, and a method of using a bonding material, an adhesive, or the like.

Further, openings of the guide pin holes 83a and 83b, openings of the micro holes for the fibers, and tips of the guide pins 9 may be tapered to facilitate insertion.

### Fourth Example

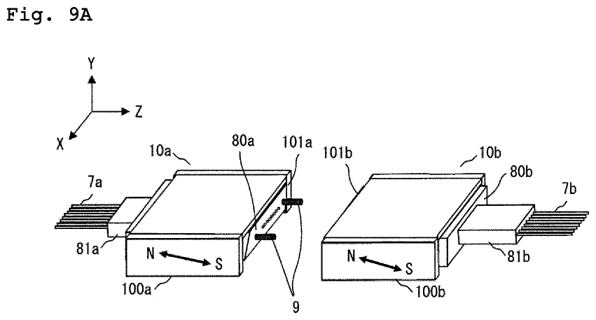

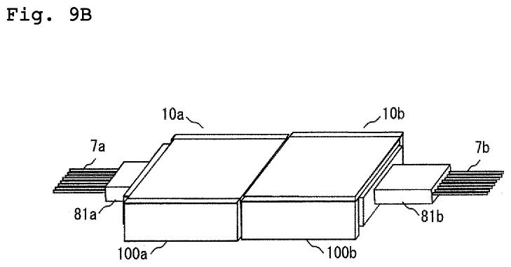

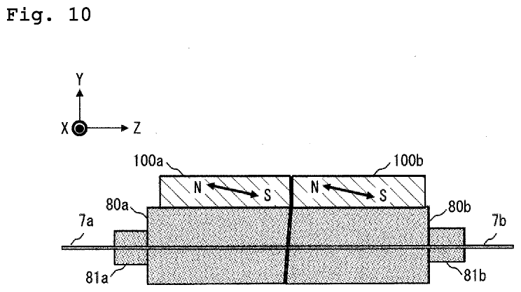

FIG. 9A is a perspective view before connection of a multicore optical connector connection structure according to a fourth example of the present invention, and FIG. 9B is a perspective view after connection of the multicore optical connector connection structure. FIG. 10 is a cross-sectional view of the multicore optical connector connection structure of FIG. 9B taken along the YZ plane.

The multicore optical connector connection structure of the present example includes an optical connector 10a attached to tips of a plurality of optical fibers 7a, an optical connector 10b attached to tips of a plurality of optical fibers 7b, and guide pins 9 that connect ferrules of the optical connectors 10a and 10b to each other.

The optical connector 10a includes a ferrule 80a (the first alignment component) attached to the tips of the optical fibers 7a, a boot 81a that bundles the optical fibers 7a, and a magnetic structure 100a (the first magnetic structure) attached to a periphery of the ferrule 80a. Similarly, the optical connector 10b includes a ferrule 80b (the second alignment component) attached to the tips of the optical fibers 7b, a boot 81b that bundles the optical fibers 7b, and a magnetic structure 100b (the second magnetic structure) attached to a periphery of the ferrule 80b.

Similarly to the third example, the guide pins 9 are inserted one by one into two guide pin holes of the ferrule 80a of the optical connector 10a, these guide pins 9 are inserted into guide pin holes of the ferrule 80b of the optical connector 10b, the ferrules 80a and 80b are butted to each other, and the optical fibers 7a and 7b are butted to each other, whereby the optical connectors 10a and 10b are connected to each other.

Similarly to the third example, connection end faces of the ferrules 80a and 80b and connection end faces of the optical fibers 7a and 7b are inclined by, for example, 8° with respect to the XY plane perpendicular to the longitudinal direction (Z axis direction) of the optical fibers 7a and 7b.

Also, a difference from the third example is that connection end faces 101a and 101b of the magnetic structures 100a and 100b are perpendicular to the longitudinal direction (Z axis direction) of the optical fibers 7a and 7b and are not inclined with respect to the XY plane.

On the other hand, in the present example, the magnetic structures 100a and 100b are made of a hard magnetic material, and their magnetization directions are inclined with respect to the Z axis direction as shown in FIGS. 9A and 10. Specifically, magnetization directions of N and S poles are set in a direction orthogonal to the connection end faces of the ferrules 80a and 80b and the connection end faces of the optical fibers 7a and 7b. However, one of the materials of the magnetic structures 100a and 100b may be a soft magnetic material or a combination of the soft magnetic material and a hard magnetic material may be used. Further, a positional relationship between the connection end faces of the magnetic structures 100a and 100b and the ferrules 80a and 80b is not limited to FIG. 10. For example, the connection end face of the magnetic structure 100a may be set to be recessed with respect to the ferrule 80a, and the connection end face of the other magnetic structure 100b may be set to protrude from the connection end face of the ferrule 80b.

In present example, since a magnetic attraction force is applied only in the direction orthogonal to the connection end faces of the optical fibers 7a and 7b and the connection end faces of the ferrules 80a and 80b, a component force is not generated in a direction orthogonal to the Z axis direction, and a component force in the sliding direction is not generated, and thus no minute deformation occurs in the guide pin holes of the ferrules 80a and 80b. As a result, the present example has the effect of being able to inhibit variations in connection loss, and realize low-loss optical connection as designed.

In addition, in the present example, it is not necessary to offset fiber hole positions in the ferrules 80a and 80b in consideration of the component force in the sliding direction. Even when the fiber hole positions in the ferrules 80a and 80b are offset, influence of the minute deformation of the guide pin holes can be eliminated, and thus offset positions can be easily set regardless of a magnetic attraction force and the material characteristics. For this reason, even when the optical connectors 10a and 10b of different vendors are connected to each other, low-loss optical connection can be realized.

In the present example, the magnetic structures 100a and 100b can be machined more easily than in the third example.

### Fifth Example

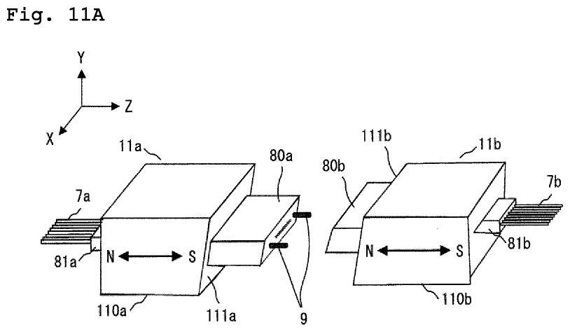

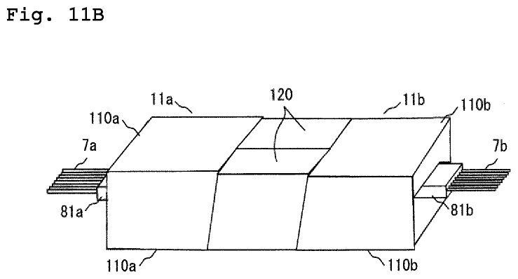

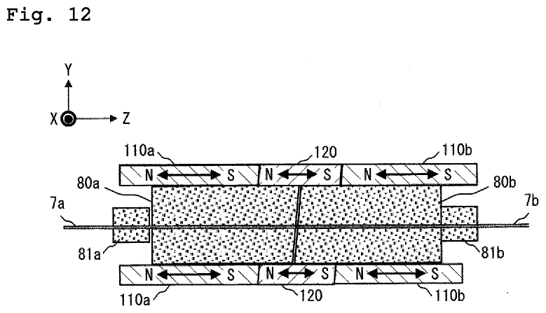

FIG. 11A is a perspective view before connection of a multicore optical connector connection structure according to a fifth example of the present invention, and FIG. 11B is a perspective view after connection of the multicore optical connector connection structure. FIG. 12 is a cross-sectional view of the multicore optical connector connection structure of FIG. 11B taken along the YZ plane.

The multicore optical connector connection structure of the present example includes an optical connector 11a attached to tips of a plurality of optical fibers 7a, an optical connector 11b attached to tips of a plurality of optical fibers 7b, and guide pins 9 that connect ferrules of the optical connectors 11a and 11b to each other.

The optical connector 11a includes a ferrule 80a (the first alignment component) attached to the tips of the optical fibers 7a, a boot 81a that bundles the optical fibers 7a, and a magnetic structure 110a (the first magnetic structure) attached to a periphery of the ferrule 80a. Similarly, the optical connector 11b includes a ferrule 80b (the second alignment component) attached to the tips of the optical fibers 7b, a boot 81b that bundles the optical fibers 7b, and a magnetic structure 110b (the second magnetic structure) attached to a periphery of the ferrule 80b.

Similarly to the third example, the guide pins 9 are inserted one by one into two guide pin holes of the ferrule 80a of the optical connector 11a, these guide pins 9 are inserted into guide pin holes of the ferrule 80b of the optical connector 11b, the ferrules 80a and 80b are butted to each other, and the optical fibers 7a and 7b are butted to each other, whereby the optical connectors 11a and 11b are connected to each other.

Also, similarly to the third example, connection end faces of the ferrules 80a and 80b and connection end faces of the optical fibers 7a and 7b are inclined by, for example, 8° with respect to the XY plane perpendicular to the longitudinal direction (Z axis direction) of the optical fibers 7a and 7b.

A difference from the third example is that the magnetic structures 110a and 110b are coupled to each other via a magnetic structure 120 (the third magnetic structure). A connection end face 111a of the magnetic structure 110a opposing the magnetic structure 120 is inclined by 8° with respect to the XY plane perpendicular to the Z axis direction to be approximately parallel to the connection end face of the ferrule 80a integrated with the magnetic structure 110a and the connection end faces of the optical fibers 7a. Similarly, a connection end face 111b of the magnetic structure 110b opposing the magnetic structure 120 is inclined by 8° with respect to the XY plane to be approximately parallel to the connection end face of the ferrule 80b integrated with the magnetic structure 110b and the connection end faces of the optical fibers 7b.

In addition, both connection end faces of the magnetic structure 120 opposing the magnetic structures 110a and 110b are inclined by 8° with respect to the XY plane to be approximately parallel to the connection end faces 111a and 111b of the magnetic structures 110a and 110b when the optical connectors 11a and 11b are connected to each other.

Materials of each of the magnetic structures 110a, 110b, and 120 and magnetization directions of N and S poles thereof are set so that magnetic attraction forces act between the magnetic structure 110a and the magnetic structure 120 and between the magnetic structure 110b and the magnetic structure 120.

The magnetic structures 110a and 110b are made of a soft magnetic material. The magnetic structure 120 is made of a hard magnetic material, specifically, a combination of two half-split magnets.

The magnetic structure 120 need not necessarily be integrated before the ferrules 80a and 80b are connected to each other. After the ferrules 80a and 80b are butted to each other as described above, the magnetic structure 120 configured of two half-split magnets is inserted between the magnetic structures 110a and 110b, and thus magnetic attraction forces can be generated between the magnetic structure 110a and the magnetic structure 120 and between the magnetic structure 110b and the magnetic structure 120.

When the connection between the optical connectors 11a and 11b is released, the magnetic structure 120 is removed from between the magnetic structures 110a and 110b, and then the connection between the ferrules 80a and 80b is released.

In the present example, since magnetic attraction forces are applied only in the direction orthogonal to the connection end faces of the ferrules 80a and 80b, the connection end faces of the optical fibers 7a and 7b, the connection end faces 111a and 111b of the magnetic structures 110a and 110b, and the connection end faces of the magnetic structure 120, a component force is not generated in the direction orthogonal to the longitudinal direction (Z axis direction) of the optical fibers 7a and 7b, a component force in the sliding direction described above is not generated, and thus minute deformation of the guide pin holes of the ferrules 80a and 80b does not occur. As a result, the present example has the effect of being able to inhibit variations in connection loss, and realize low-loss optical connection as designed.

Also, in the present example, it is not necessary to offset fiber hole positions in the ferrules 80a and 80b in consideration of the component force in the sliding direction. Even when the fiber hole positions in the ferrules 80a and 80b are offset, influence of the minute deformation of the guide pin holes can be eliminated, and thus offset positions can be easily set regardless of a magnetic attraction force and material characteristics. For this reason, even when the optical connectors 11a and 11b of different vendors are connected to each other, low-loss optical connection can be realized.

Further, in the present example, by adopting the configuration in which the magnetic structure 120 is attached later, there is no need to worry about the magnetic attraction force between the magnetic structures 110a and 110b when the ferrules 80a and 80b are butted to each other, and thus an effect that workability at the time of connection can be improved is also achieved.

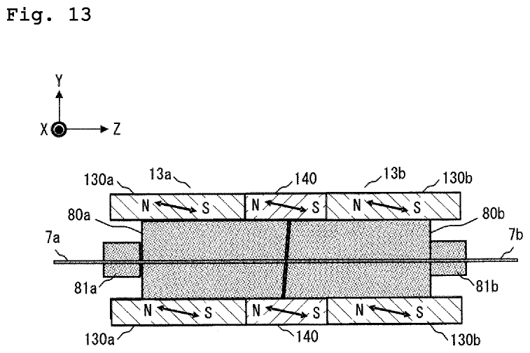

FIG. 13 shows a modified example of the present example. A multicore optical connector connection structure of FIG. 13 includes an optical connector 13a attached to tips of a plurality of optical fibers 7a, an optical connector 13b attached to tips of a plurality of optical fibers 7b, and guide pins (not shown) that connect ferrules of the optical connectors 13a and 13b to each other.

The optical connector 13a includes a ferrule 80a (the first alignment component) attached to the tips of the optical fibers 7a, a boot 81a that bundles the optical fibers 7a, and a magnetic structure 130a (the first magnetic structure) attached to a periphery of the ferrule 80a. Similarly, the optical connector 13b includes a ferrule 80b (the second alignment component) attached to the tips of the optical fibers 7b, a boot 81b that bundles the optical fibers 7b, and a magnetic structure 130b (the second magnetic structure) attached to a periphery of the ferrule 80b.

Similarly to the third example, the guide pins 9 are inserted one by one into two guide pin holes of the ferrule 80a of the optical connector 13a, these guide pins 9 are inserted into guide pin holes of the ferrule 80b of the optical connector 13b, the ferrules 80a and 80b are butted to each other, and the optical fibers 7a and 7b are butted to each other, whereby the optical connectors 13a and 13b are connected to each other.

A difference from the configurations shown in FIGS. 11A, 11B, and 12 is that connection end faces of the magnetic structures 130a and 130b are perpendicular to the longitudinal direction (Z axis direction) of the optical fibers 7a and 7b and are not inclined with respect to the XY plane. In addition, both connection end faces of the magnetic structure 140 inserted between the magnetic structures 130a and 130b are also faces perpendicular to the Z axis direction.

Further, magnetization directions of the magnetic structures 130a 130b, and 140 are inclined with respect to the Z axis direction as shown in FIG. 13. Specifically, magnetization directions of N and S poles are set in a direction orthogonal to the connection end faces of the ferrules 80a and 80b and the connection end faces of the optical fibers 7a and 7b.

In this way, the structure shown in FIG. 13 can obtain the same effects as those shown in FIGS. 11A, 11B, and 12. In addition, the magnetic structures 130a, 130b, and 140 can be machined more easily than the structures shown in FIGS. 11A, 11B, and 12.

In addition, in the present example, a soft magnetic material may be used for the material of the magnetic structure 120, and a hard magnetic material may be used for the material of at least one of the magnetic structures 110a and 110b.

### Sixth Example

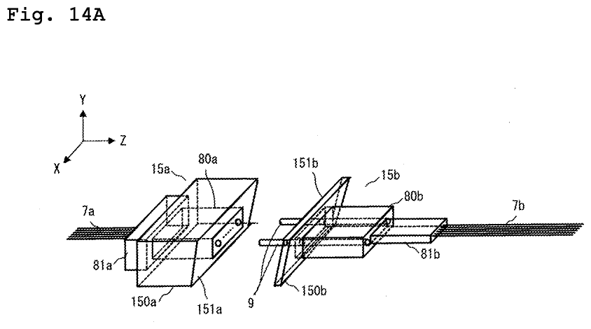

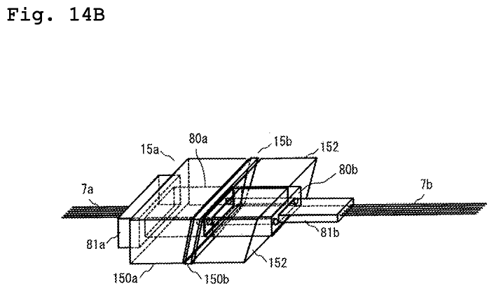

FIG. 14A is a perspective view before connection of a multicore optical connector connection structure according to a sixth example of the present invention, and FIG. 14B is a perspective view after connection of the multicore optical connector connection structure.

The multicore optical connector connection structure of the present example includes an optical connector 15a attached to tips of a plurality of optical fibers 7a, an optical connector 15b attached to tips of a plurality of optical fibers 7b, and guide pins 9 that connect ferrules of the optical connectors 15a and 15b to each other.

The optical connector 15a includes a ferrule 80a (the first alignment component) attached to the tips of the optical fibers 7a, a boot 81a that bundles the optical fibers 7a, and a magnetic structure 150a (the first magnetic structure) attached to a periphery of the ferrule 80a. Similarly, the optical connector 15b includes a ferrule 80b (the second alignment component) attached to the tips of the optical fibers 7b, a boot 81b that bundles the optical fibers 7b, and a magnetic structure 150b (a first member forming the second magnetic structure) attached to a periphery of the ferrule 80b.

Similarly to the third example, the guide pins 9 are inserted one by one into two guide pin holes of the ferrule 80a of the optical connector 15a, these guide pins 9 are inserted into guide pin holes of the ferrule 80b of the optical connector 15b, and the ferrules 80a and 80b are butted to each other, thereby connecting the optical connectors 15a and 15b to each other.

Similarly to the third example, connection end faces of the ferrules 80a and 80b and connection end faces of the optical fibers 7a and 7b are inclined by, for example, 8° with respect to the XY plane perpendicular to the longitudinal direction (Z axis direction) of the optical fibers 7a and 7b.

Materials of each of the magnetic structures 150a and 150b and magnetization directions of N and S poles are set so that a magnetic attraction force acts between the magnetic structure 150a attached to the periphery of the ferrule 80a and the magnetic structures 150b attached to the periphery of the ferrule 80b.

A connection end face 151a of the magnetic structure 150a opposing the magnetic structure 150b is inclined by 8° with respect to the XY plane perpendicular to the Z axis direction to be approximately parallel to the connection end face of the ferrule 80a integrated with the magnetic structure 150a and the connection end faces of the optical fibers 7a. Similarly, a connection end face 151b of the magnetic structure 150b opposing the magnetic structure 150a is inclined by 8° with respect to the XY plane to be approximately parallel to the connection end face of the ferrule 80b integrated with the magnetic structure 150b and the connection end faces of the optical fibers 7b.

The magnetic structure 150a is made of SUS403 or SUS430 which is a soft magnetic material. The magnetic structure 150b is made of SUS403 or SUS430 which is a soft magnetic material, and its length in the Z axis direction is set shorter than those of the magnetic structure 150a and the ferrules 80a and 80b.

A difference from the third example is that the ferrules 80a and 80b are butted to each other as described above, and then a magnetic structure 152 (a second member forming the second magnetic structure) configured of two half-split magnets is attached behind the magnetic structure 150b opposing the magnetic structure 150a. The magnetic structure 152 is made of, for example, a neodymium magnet.

In the present example, by adopting a configuration in which the magnetic structure 152 is attached later, there is almost no need to worry about the magnetic attraction force between the magnetic structures 150a and 150b when the ferrules 80a and 80b are butted to each other, and thus an effect that workability at the time of connection can be improved is also achieved. Further, when the magnetic structure 152 is attached, a magnetic attraction force is generated between the magnetic structure 150a and the magnetic structures 150b and 152, and thus the ferrules 80a and 80b can be pressed against each other. In this way, in the present example, the same effects as those of the first to fifth examples can be obtained.

When the connection between the optical connectors 15a and 15b is released, the magnetic structure 152 is removed from the magnetic structure 150b, and then the connection between the ferrules 80a and 80b is released. Accordingly, attaching and detaching work of the optical connectors 15a and 15b can be easily performed.

Also, although not shown in the drawings, two soft magnetic materials (SUS403 or SUS430) having a half-split structure may be attached as a yoke to a fiber draw-out side of the magnetic structure 150b.

Although the first to sixth examples have been described above, it is needless to say that the present invention can be applied to any combination of connection objects, connection structures, connection end faces, positioning structures, magnetic structures, materials and arrangements of various constituent elements described in the first to sixth examples.

For example, in the first to sixth examples, configurations in which the connection end faces of the magnetic structures are inclined to the direction orthogonal to the longitudinal direction of the optical fibers, and the magnetization directions of the magnetic structures are set in the direction orthogonal to the connection end faces of the ferrules and the optical fibers have been described, but the connection end faces of the magnetic structures may be inclined with respect to the direction orthogonal to the longitudinal direction of the optical fibers, and the magnetization directions of the magnetic structures may be set in the direction orthogonal to the connection end faces of the ferrules and the optical fibers.

### INDUSTRIAL APPLICABILITY

The present invention can be applied to a technique for connecting optical connectors.

### REFERENCE SIGNS LIST

1a, 1b Optical fiber
2a, 2b, 4a, 4b, 5a, 5b, 6a, 6b, 8a, 8b, 10a, 10b, 11a, 11b, 13a, 13b, 15a, 15b Optical connector
3 Split sleeve
9 Guide pin
20a, 20b, 80a, 80b Ferrule
21a, 21b, 30, 32, 33, 35, 41a, 41b, 48a, 48b, 51a, 51b, 61a, 61b, 82a, 82b, 100a, 100b, 110a, 110b, 120, 130a, 130b, 140, 150a, 150b, 152 Magnetic structure
23a, 23b, 34 Capillary
81a, 81b Boot
83a, 83b Guide pin hole

1. An optical connector connection structure comprising:
a first optical connector attached to a tip of a first optical fiber; and
a second optical connector attached to a tip of a second optical fiber and connectable to the first optical connector, wherein
the first optical connector includes
a first alignment component configured to fix the first optical fiber, and
a first magnetic structure integrated with the first alignment component,
the second optical connector includes
a second alignment component configured to fix the second optical fiber, and
a second magnetic structure integrated with the second alignment component,
connection end faces of the first and second optical fibers and connection end faces of the first and second alignment components, which are opposed to each other in the case of connecting the first optical connector to the second optical connector, are inclined with respect to a direction orthogonal to a longitudinal direction of the first and second optical fibers so that all of the end faces are parallel to each other,
connection end faces of the first and second magnetic structures, which are opposed to each other in the case of connecting the first optical connector to the second optical connector, are inclined with respect to the direction orthogonal to a longitudinal direction of the first and second optical fibers so that they are parallel to the connection end faces of the first and second optical fibers and the connection end faces of the first and second alignment components, and a magnetic force generated between the first and second magnetic structures acts in a direction orthogonal to the connection end faces of the first and second optical fibers and the connection end faces of the first and second alignment components.

2. An optical connector connection structure comprising:
a first optical connector attached to a tip of a first optical fiber; and
a second optical connector attached to a tip of a second optical fiber and connectable to the first optical connector, wherein
the first optical connector includes
a first alignment component configured to fix the first optical fiber, and
a first magnetic structure integrated with the first alignment component,
the second optical connector includes
a second alignment component configured to fix the second optical fiber, and
a second magnetic structure integrated with the second alignment component,
connection end faces of the first and second optical fibers and connection end faces of the first and second alignment components, which are opposed to each other in the case of connecting the first optical connector to the second optical connector, are inclined with respect to a direction orthogonal to a longitudinal direction of the first and second optical fibers so that all of the end faces are parallel to each other,
at least one of the first and second magnetic structures includes a structure made of a hard magnetic material so that a magnetic force generated between the first and second magnetic structures in the case of connecting the first optical connector to the second optical connector acts in a direction orthogonal to the connection end faces of the first and second optical fibers and the connection end faces of the first and second alignment components, and a magnetization direction of the hard magnetic material is set in the direction orthogonal to the connection end faces of the first and second optical fibers and the connection end faces of the first and second alignment components.

3. The optical connector connection structure according to claim 1, further comprising:
a split sleeve configured to connect the first optical connector to the second optical connector; and
a third magnetic structure attached to a periphery of the split sleeve to provide connection between the first magnetic structure and the second magnetic structure in the case of connecting the first optical connector to the second optical connector, wherein
the first alignment component is a cylindrical ferrule that fixes the first optical fiber such that the connection end face of the first optical fiber is exposed on the connection end face thereof,
the second alignment component is a cylindrical ferrule that fixes the second optical fiber such that the connection end face of the second optical fiber is exposed on the connection end face thereof;
the first and second alignment components are inserted into the split sleeve from both sides of the split sleeve and positioned in the case of connecting the first optical connector to the second optical connector so that the connection end faces of the first and second alignment components are butted to each other,
both connection end faces of the third magnetic structure opposing the connection end faces of the first and second magnetic structures in the case of connecting the first optical connector to the second optical connector are inclined with respect to the direction orthogonal to the longitudinal direction of the first and second optical fibers so that they are parallel to the connection end faces of the first and second optical fibers and the connection end faces of the first and second alignment components, and
the first magnetic structure and the second magnetic structure are connected to each other by a magnetic force via the third magnetic structure.

4. The optical connector connection structure according to claim 2, further comprising:
a split sleeve configured to connect the first optical connector to the second optical connector: and
a third magnetic structure attached to a periphery of the split sleeve to provide connection between the first magnetic structure and the second magnetic structure in the case of connecting the first optical connector to the second optical connector, wherein
the first alignment component is a cylindrical ferrule that fixes the first optical fiber such that the connection end face of the first optical fiber is exposed on the connection end face thereof,
the second alignment component is a cylindrical ferrule that fixes the second optical fiber such that the connection end face of the second optical fiber is exposed on the connection end face thereof;
the first and second alignment components are inserted into the split sleeve from both sides of the split sleeve and positioned in the case of connecting the first optical connector to the second optical connector so that the connection end faces of the first and second alignment components are butted to each other,
at least one of the first, second, and third magnetic structures includes a structure made of a hard magnetic material so that the first magnetic structure and the second magnetic structure are connected to each other by a magnetic force via the third magnetic structure in the case of connecting the first optical connector to the second optical connector, and a magnetization direction of the hard magnetic material is set in the direction orthogonal to the connection end faces of the first and second optical fibers and the connection end faces of the first and second alignment components.

5. The optical connector connection structure according to claim 1 or 2, further comprising
a guide pin configured to connect the first optical connector to the second optical connector, wherein
the first alignment component is a ferrule including a guide pin hole and fixes the first optical fiber so that connection end faces of a plurality of the first optical fibers are exposed on the connection end face thereof,
the second alignment component is a ferrule including a guide pin hole and fixes the second optical fiber so that connection end faces of a plurality of the second optical fibers are exposed on the connection end face thereof, and
the guide pin is inserted into the guide pin holes of each of the first and second alignment components in the case of connecting the first optical connector to the second optical connector and positioned such that the connection end faces of the first and second alignment components are butted to each other.

6. The optical connector connection structure according to claim 5, wherein
the first magnetic structure is made of a soft magnetic material, and
the second magnetic structure includes
a first member made of a soft magnetic material opposing the first magnetic structure in the case of connecting the first optical connector to the second optical connector, and
a second member made of a hard magnetic material disposed on an end face side opposite to a connection end face of the first member.

7. The optical connector connection structure according to claim 1, further comprising:
a guide pin configured to connect the first optical connector to the second optical connector; and
a third magnetic structure disposed to provide connection between the first magnetic structure and the second magnetic structure in the case of connecting the first optical connector to the second optical connector, wherein
the first alignment component is a ferrule including a guide pin hole and fixes the first optical fiber so that connection end faces of a plurality of the first optical fibers are exposed on the connection end face thereof,
the second alignment component is a ferrule including a guide pin hole and fixes the second optical fiber so that connection end faces of a plurality of the second optical fibers are exposed on the connection end face thereof,
the guide pin is inserted into the guide pin holes of the first and second alignment components in the case of connecting the first optical connector to the second optical connector and positioned so that the connection end faces of the first and second alignment components are butted to each other,
both connection end faces of the third magnetic structure opposing the connection end faces of the first and second magnetic structures in the case of connecting the first optical connector to the second optical connector are inclined with respect to the direction orthogonal to the longitudinal direction of the first and second optical fibers so that they are parallel to the connection end faces of the first and second optical fibers and the connection end faces of the first and second alignment components, and
the first magnetic structure and the second magnetic structure are connected to each other by a magnetic force via the third magnetic structure.

8. The optical connector connection structure according to claim 2, further comprising:
a guide pin configured to connect the first optical connector to the second optical connector; and
a third magnetic structure disposed to provide connection between the first magnetic structure and the second magnetic structure in the case of connecting the first optical connector to the second optical connector, wherein
the first alignment component is a ferrule including a guide pin hole and fixes the first optical fiber so that connection end faces of a plurality of the first optical fibers are exposed on the connection end face thereof,
the second alignment component is a ferrule including a guide pin hole and fixes the second optical fiber so that connection end faces of a plurality of the second optical fibers are exposed on the connection end face thereof,
the guide pin is inserted into the guide pin holes of the first and second alignment components in the case of connecting the first optical connector to the second optical connector and positioned so that the connection end faces of the first and second alignment components are butted to each other,
at least one of the first, second, and third magnetic structures includes a structure made of a hard magnetic material so that the first magnetic structure and the second magnetic structure are connected to each other by a magnetic force via the third magnetic structure in the case of connecting the first optical connector to the second optical connector, and a magnetization direction of the hard magnetic material is set in the direction orthogonal to the connection end faces of the first and second optical fibers and the connection end faces of the first and second alignment components.
